(19) United States
(12) Patent Application Publication
(10) Pub. No.: US 2008/0264035 A1
(43) Pub. Date: Oct. 30, 2008

(54) COOLANT FLOW SWIRLER FOR A ROCKET ENGINE

(76) Inventor: Mark J. Ricciardo, Jupiter, FL (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 11/739,751

(22) Filed: Apr. 25, 2007

(51) Int. Cl. F02K 11/00; F02K 9/00; F02K 9/64

(52) U.S. Cl. 60/267; 60/200.1; 60/206

(57) ABSTRACT

A thrust chamber assembly cooling system includes a twisted ribbon/wire of any one of many variety of cross-sectional shapes located within a nozzle assembly cooling passage to direct the coolant to flow in a swirling manner which induces mixing and breaks up the boundary layer in the coolant passage to enhance the convective heat transfer.

### BACKGROUND OF THE INVENTION

The present invention relates to a cooling system, and more particularly to a cooling system for a rocket engine thrust chamber assembly.

During operation of a rocket engine, turbopumps supply a fuel and oxidizer, such as hydrogen and oxygen, to the combustion chamber. The oxygen and hydrogen are expanded in the combustion chamber and combusted to produce hot, pressurized gases. The hot, pressurized gases are flowed at high velocities to the exhaust nozzle. The exhaust nozzle allows further expansion of the gases to increase the velocity of the gases before the gases exit the engine, thereby increasing the thrust of the rocket engine.

The engine nozzle assembly is typically fabricated from thin walled tubes or milled channels that are tapered and shaped to form the required nozzle contour. The fuel is used as a coolant and is flowed through these tubes to provide convective cooling to the tubes and regenerative heating to the fuel. The convective cooling ensures that the temperature of the tubes is consistent with the temperature limits required for structural integrity of the nozzle.

Certain rocket engine cycles, such as the expander cycle, rely on the heat transferred between the combustion gasses and the coolant to power the engine. The amount of heat transfer to the coolant is a significant contributor regarding the limitations of the amount of power, or thrust, an expander cycle engine can generate. The reliability of the combustion chamber is also heavily dependent on the effectiveness of the cooling circuit.

Accordingly, it is desirable to provide an efficient cooling system for a thrust chamber assembly which enhances the convective heat transfer.

### SUMMARY OF THE INVENTION

The cooling system according to the present invention includes a twisted ribbon/wire of any variety of cross-sectional shapes located within a nozzle assembly cooling passage along the entire passage or in specific sections of the passage.

The twisted ribbon/wire forces the coolant to flow in a swirling manner which induces mixing and breaks up the boundary layer in the coolant passage to enhance the convective thermal transfer. This will result in enhanced cooling of the chamber walls and increase the temperature of the coolant to provide additional energy to the engine, specifically the turbopump. Swirling flow also minimizes the potential for temperature stratification inside a particular coolant passage.

The reliability of the engine is enhanced by operations with a colder chamber wall which increases the material strength capability and reduces chamber wall susceptibility to hot streaks caused by non-uniformities in the coolant circuit or the combustion environment. More efficient cooling of the chamber wall facilitates engine operation at higher power or oxidizer/fuel mixture ratio.

The present invention therefore provides an efficient cooling system for a thrust chamber assembly which enhances the convective heat transfer.

### BRIEF DESCRIPTION OF THE DRAWINGS

The various features and advantages of this invention will become apparent to those skilled in the art from the following detailed description of the currently disclosed embodiment. The drawings that accompany the detailed description can be briefly described as follows:

FIG. 1 is a general perspective view of an exemplary of rocket engine embodiment for use with the present invention;

FIG. 2A is a schematic perspective view of a thrust chamber assembly of the present invention;

FIG. 2B is an expanded view of the thrust chamber assembly illustrating the coolant passages;

FIG. 3A is a perspective view of one embodiment of one type of flow swirler; and

FIG. 3B is a perspective view of another type of flow swirler.

### DETAILED DESCRIPTION OF THE DISCLOSED EMBODIMENT

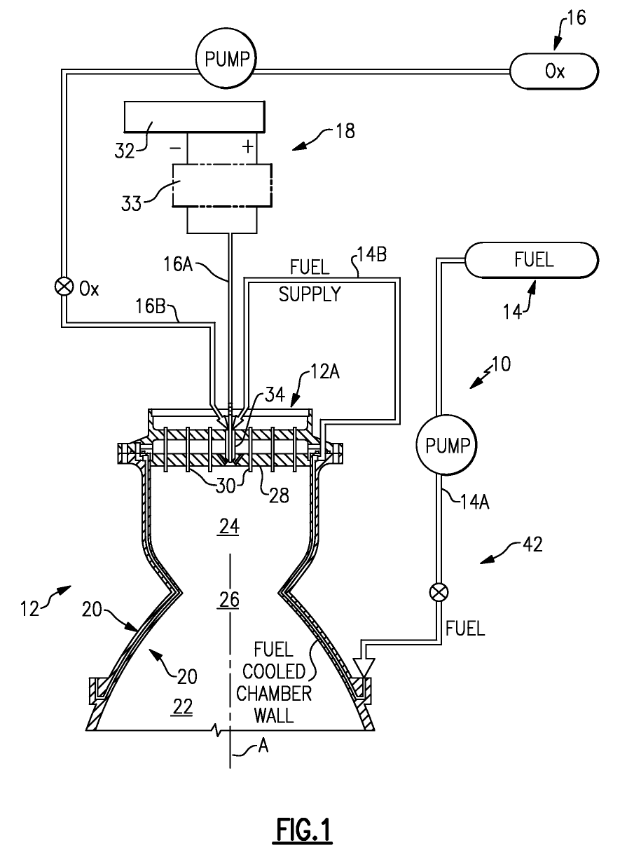

FIG. 1 illustrates a general schematic view of a rocket engine 10. The engine 10 generally includes a thrust chamber assembly 12, a fuel system 14, an oxidizer system 16 and an ignition system 18. The fuel system 14 and the oxidizer system 16 provide a gaseous propellant system of the rocket engine 10, however, other fluid propellant systems such as liquid will also be usable with the present invention.

The thrust chamber assembly 12 is defined by a fluid cooled wall 20 about a thrust axis A. The fluid cooled wall 20 defines a nozzle section 22, a combustion chamber 24 upstream of the nozzle section 22, and a combustion chamber throat 26 therebetween. The thrust chamber assembly 12 includes an injector 12A with an injector face 28 which contains a multitude of fuel/oxidizer injector elements 30 (shown somewhat schematically) which receive fuel which passes first through the fluid cooled wall 20 fed via fuel supply line 14A of the fuel system 14 and an oxidizer such as Gaseous Oxygen (GOx) through an oxidizer supply line 16A of the oxidizer system 16.

The ignition system 18 generally includes a power supply 32 and an electrical conditioning system 33 to power an igniter 34 mounted within the injector 12A to ignite the fuel/oxidizer propellant flow from the fuel/oxidizer injector elements 30. The oxidizer is fed to the igniter via a dedicated line 16B in this embodiment, and the fuel is also fed to the igniter torch via a dedicated line 14B. Ignition of the fuel/oxidizer propellant flow from the fuel/oxidizer injector elements 30 with the igniter 34 is conventional and need not be described in further detail herein.

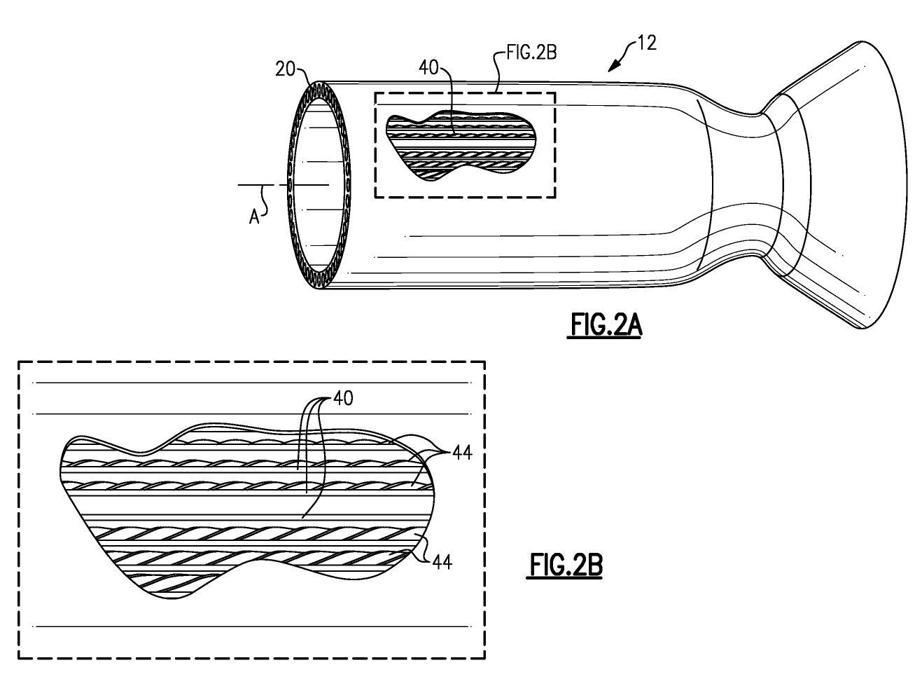

Referring to FIG. 2A, the fluid cooled wall 20 of the nozzle assembly 12 includes a multiple of passages 40 defined therein (also illustrated in FIG. 2B). The multiple of passages 40 within the fluid cooled wall 20 forms a section of a cooling system 42 (illustrated schematically), which utilizes fuel as a coolant via fuel supply line 14A of the fuel system 14. It should be understood that although the passages 40 are generally parallel to the axis A and are illustrated within the combustion chamber 24, other combustion based devices such as jet, rocket, hypersonic, and others as well as any section thereof, such as the nozzle section 22 and/or the combustion chamber throat 26, may also include the fluid cooled wall 20 of the present invention.

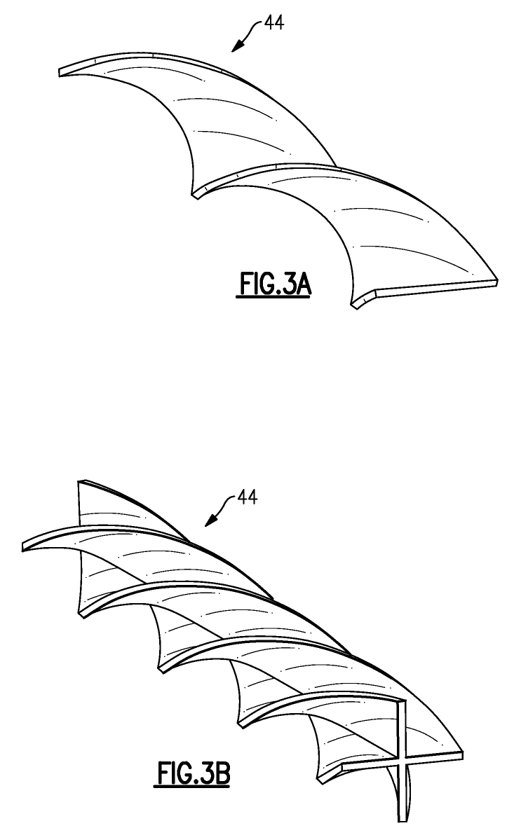

Some of or all of the multiple of passages 40 include a flow swirler 44 along the entire passage or in specific sections of the passages 40. The flow swirler 44 generally includes a twisted ribbon and/or wire bundle in any of a variety of cross-sectional shapes (FIG. 3A, 3B). The flow swirler 44 takes a generally helical shape which is essentially a three-dimensional curve that twists around an axis. It should be further understood that the flow swirler 44 may take various twisted forms which rotate the coolant but need not exactly meet the mathematical definition of a “spiral” or “helix.”

The flow swirler 44 forces the coolant to flow in a swirling manner which induces mixing and breaks up the boundary layer in the coolant passages 40 to enhance convective heat transfer. This enhances cooling of the fluid cooled wall 20 and increase the temperature of the coolant to provide additional energy to the engine, specifically the turbopump turbine(s). Swirling flow also minimizes the potential for temperature stratification inside a particular coolant passage.

Engine reliability is enhanced by operation with a lower temperature thrust chamber assembly 12 which increases the material strength capability such that the fluid cooled wall 20 is less susceptible to hot streaks caused by non-uniformities in the coolant circuit or the combustion environment. More efficient cooling of the fluid cooled wall 20 facilitates operation of the engine at higher power or oxidizer/Fuel mixture ratio.

It should be understood that relative positional terms such as “forward,” “aft,” “upper,” “lower,” “above,” “below,” and the like are with reference to the normal operational attitude of the vehicle and should not be considered otherwise limiting.

It should be understood that although a particular component arrangement is disclosed in the illustrated embodiment, other arrangements will benefit from the instant invention.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The disclosed embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A fluid cooled wall for a thrust chamber assembly comprising:
a wall having at least one passage; and
a flow swirler located within said at least one passage.

2. The fluid cooled wall as recited in claim 1, wherein said at least one passage includes a multiple of passages.

3. The fluid cooled wall as recited in claim 1, wherein said at least one passage is defined generally parallel to an engine axis.

4. The fluid cooled wall as recited in claim 1, wherein said at least one passage is formed along a combustion chamber.

5. The fluid cooled wall as recited in claim 1, wherein said at least one passage is formed along a thrust chamber.

6. The fluid cooled wall as recited in claim 1, wherein said flow swirler is a twisted shape.

7. The fluid cooled wall as recited in claim 1, wherein said flow swirler is of a helical-shape.

8. A rocket engine comprising:
a thrust chamber assembly having a wall with at least one passage therein; and
a flow swirler located within said at least one passage.

9. The rocket engine as recited in claim 8, wherein said thrust chamber assembly includes a combustion chamber.

10. The rocket engine as recited in claim 8, further comprising a cooling system which communicates a coolant through said at least one passage.

11. The rocket engine as recited in claim 10, wherein said coolant includes a fuel.

12. The rocket engine as recited in claim 8, wherein said at least one passage includes a multiple of passages generally parallel to an engine axis.

13. A method of cooling a rocket engine thrust chamber assembly comprising the steps of:
(A) communicating a coolant through at least one passage in a thrust chamber assembly wall; and
(B) swirling the coolant within the at least one passage.

14. A method as recited in claim 13, wherein said step (A) further comprises:
(a) communicating fuel as the coolant.

15. A method as recited in claim 13, wherein said step (B) further comprises:
(a) inducing mixing in the at least one coolant passage.

16. A method as recited in claim 13, wherein said step (B) further comprises:
(a) breaking-up a boundary layer within at least one coolant passage.
